(19) United States
(12) Patent Application Publication
(10) Pub. No.: US 2008/0205285 A1
(43) Pub. Date: Aug. 28, 2008

(54) REMOTE NETWORK ELEMENT TESTING IN A BROADBAND COMMUNICATIONS NETWORK

(76) Inventor: John Scherer, Jacksonville, FL (US)

Correspondence Address: WITHERS & KEYS FOR BELL SOUTH, P. O. BOX 71355, MARIETTA, GA, 30007-1355, US

(21) Appl. No.: 11/679,066

(22) Filed: Feb. 26, 2007

(51) Int. Cl. H04J 1/16

(52) U.S. Cl. 370/245; 370/249

(57) ABSTRACT

An apparatus is provided for remotely monitoring and testing network elements using a broadband communications network which may be a digital subscriber line network. One or more network elements may be in communication with a remote terminal device via a network gateway over the broadband communications network. The remote terminal device may be configured for communicating commands for monitoring and testing the network elements and for retrieving graphics responsive to the testing commands, generated by the network elements, via the network gateway over the network interface. The retrieved graphics may then be displayed to a user of the remote terminal device to provide an indication of a status of the tested network elements. The apparatus may further include a communications adapter in communication with the network gateway for enabling voice communications over the broadband communications network with network element sites where the network elements are located.

### BACKGROUND

Telecommunications service providers offer and support a number of services for customers including narrowband services such as Plain Old Telephone Service (“POTS”) as well as broadband services such as Voice over Internet Protocol (“VOIP”) and Internet protocol television (“IPTV”). Service providers typically monitor and test various network elements which are utilized for providing these narrowband and broadband services in their networks. Network elements may include fiber optic multiplexers, switches, routers, intelligent peripherals (“IPs”), digital loop carrier (“DLC”) equipment, and subscriber loop carrier (“SLC”) equipment. For example, service technicians may use mechanized loop testing equipment to monitor and test narrowband network elements for dial tone. Monitoring and testing may be carried out by service technicians at remote terminal (“RT”) sites utilizing a testing system to remotely access and communicate with network elements over the public switched telephone network (“PSTN”) using a terminal emulation program such as Telnet.

Current testing systems utilized for remote network element monitoring and testing, however, suffer from a number of drawbacks. One drawback is that communication speeds over current testing system interfaces utilizing narrowband PSTN lines are limited to 9600 bps or slower. These existing communication speeds introduce a number of limitations in network element testing including the inability to retrieve graphical status information which may be generated by various broadband network elements. As a result, technicians are hindered in not being able to visually “see” network element configuration and status information, such as alarms, and must instead manually communicate several commands over the narrowband network to retrieve the same information. Another drawback associated with current remote testing and monitoring systems is that technicians may be forced to assume certain network conditions due to the limited information which can be returned over the narrowband network. For example, currently technicians performing a loopback test are unable to visually see a confirmation of transmitted commands and thus must speculate whether the commands were received by a network element. Yet another drawback that is associated with current remote testing and monitoring systems is that technicians must use customer telephone lines to borrow dial tone for talking to network element sites thereby potentially cutting off existing customer use (such as telephone conversations) on the lines. It is with respect to these and other considerations that the present invention has been made.

### SUMMARY

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

Various embodiments utilizing the techniques described herein solve the above and other problems by providing an apparatus for remotely monitoring and testing network elements using a broadband communications network which may be a digital subscriber line communications network. The apparatus may include a remote terminal device having a network interface in communication with a network gateway. The remote terminal device may be configured for communicating commands for monitoring and testing the network elements and for retrieving graphics responsive to the monitoring and testing commands, generated by the network elements, via the network gateway over the network interface. The retrieved graphics may then be displayed to a user of the remote terminal device to provide an indication of a status of the tested network elements. They apparatus may further include a communications adapter in communication with the network gateway for enabling voice communications over the broadband communications network with network element sites where the network elements are located.

Other systems, methods, and/or computer program products according to various embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

FIG. 1 is a network architecture diagram illustrating aspects of network devices utilized in and provided by various embodiments of the invention; and

FIG. 2 is a flow diagram illustrating aspects of a process for remotely monitoring and testing network elements in a broadband communications network in accordance with various embodiments of the invention.

### DETAILED DESCRIPTION

As briefly described above, embodiments of the present invention are directed to providing a system for remotely monitoring and testing network elements using a broadband communications network. In the following detailed description, references are made to the accompanying drawings that form a part hereof, and in which are shown by way of illustrations specific embodiments or examples. These embodiments may be combined, other embodiments may be utilized, and structural changes may be made without departing from the spirit or scope of the present invention. The following detailed description is therefore not to be taken in a limiting sense, and the scope of the present invention is defined by the appended claims and their equivalents.

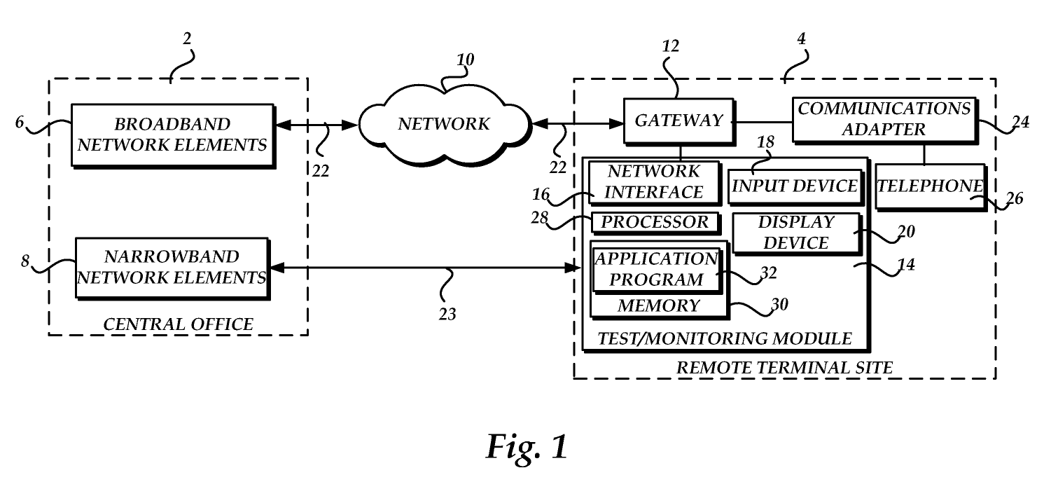

Referring now to the drawings, in which like numerals represent like elements through the several figures, various aspects of the present invention and an illustrative network environment will be described. In particular, FIG. 1 and the corresponding discussion are intended to provide a brief, general description of a suitable network in which the invention may be implemented.

Embodiments of the invention may be implemented as a computer process, a computing device, or as an article of manufacture, such as a computer program product or computer-readable media. The computer program product may be a computer storage media readable by a computer system and encoding a computer program of instructions for executing a computer process. The computer program may also be a propagated signal on a carrier readable by a computing system and encoding a computer program of instructions for executing a computer process.

Referring now to FIG. 1, an illustrative network environment for the several embodiments, utilizing the techniques described herein, will be described. As shown in FIG. 1, a central office 2 is in communication with a remote terminal site 4 over a network 10. In accordance with various embodiments, the network 10 may comprise any type of computing network including a wide area computing network, such as the Internet. It should be understood that the broadband network communications between the central office 2 and the remote terminal site 4 may be facilitated by digital subscriber lines (“DSL”) which enable broadband data communications over existing copper telephone lines such as communication lines 22. It should be further understood that narrowband network communications between the central office 2 and the remote terminal site 4 may be facilitated by plain old telephone service (“POTS”) communications lines 23.

In accordance with various embodiments, the central office 2 may comprise various broadband network elements 6 for providing broadband network services such as Voice over Internet Protocol (“VOIP”) and Internet protocol television (“IPTV”) to subscribers in a telecommunications network. The broadband network elements 6 are in communication with the network 10 over the communications lines 22. The central office 2 may also comprise various narrowband network elements 8 for providing POTS to network subscribers. The narrowband network elements 8 are in direct communication with the remote terminal site 4 over the communications lines 23. It should be appreciated that the broadband network elements 6 and the narrowband network elements 8 may include, without limitation, fiber optic multiplexers, switches (including Asynchronous Transfer Mode (“ATM”) switches), routers, intelligent peripherals (“IPs”), digital loop carrier (“DLC”) equipment, subscriber loop carrier (“SLC”) equipment, Ethernet equipment (including Gigabit Ethernet), and Digital subscriber line access multiplexers (“DSLAMs”).

In accordance with various embodiments, the remote terminal site 4 may comprise a gateway 12, test/monitoring module 14, a communications adapter 24, and a telephone 26. The gateway 12 may comprise a broadband modem for communicating with the broadband network elements 6 over the network 10. The gateway 12 may be configured for wired and/or wireless communication with the test/monitoring equipment 14 and the terminal adapter 24 over an Ethernet or Wi-Fi local area network. As will be understood by those skilled in the art, the local area network utilized in various embodiments utilizing the techniques described herein, may support any number of wired and wireless networking standards and specifications including, but not limited to, 10Base-T, 100Base-T, gigabit Ethernet (i.e., 1000Base-T), and the 802.11 family of specifications for wireless local area networks developed by the Institute of Electrical and Electronics Engineers (“IEEE”), including 802.11a, 802.11b, 802.11g, 802.11n, and WiMAX, said standards and specifications being incorporated herein by reference.

The test/monitoring module 14 in the remote terminal site 4, in accordance with various embodiments, may be a remote terminal device utilized for communicating testing and monitoring commands to the broadband network elements 6 and for receiving test results and monitoring data, including graphics, from the broadband network elements 6. It should be understood by those skilled in the art that, in accordance with various embodiments, the test/monitoring module 14 may be configured to download graphics which are generated by the broadband network elements 6 and which are indicative of a current status of various broadband network element components. For instance, the graphics may provide a visual confirmation of deleted options and include real-time or near real-time graphical representations of a network element shelf and a shelf status, a network element card and a card status, alarms which may be present on a network element card or cards, network element card and shelf status indicators (e.g., lights), and the like. It should be appreciated that the graphics may provide a visual representation of the components in the broadband network elements 6 to a remotely located technician in the remote terminal site 4.

The test/monitoring module 14 may comprise a personal or laptop computer or other computing device (including, but not limited to, cellular telephones, Personal Digital Assistants, and the like) and include a network interface 16, an input device 18, a display device 20, a processor 28, and a memory storage 30 for storing an application program 32. The application program 32 may be utilized for initiating testing and monitoring commands to the broadband network elements 6 and for instructing the test/monitoring module 14 to display received test results and monitoring data, including graphics, from the broadband network elements 6.

The network interface 16 may comprise an Ethernet or Wi-Fi network interface, such as a network interface card, for enabling communications with the broadband network elements 6 over the network 10 via the gateway 12. The input device 18 may be utilized for entering testing and monitoring commands and may include a keyboard, mouse, or electronic stylus. The display device 20 may be utilized for displaying received test results and monitoring data, including graphics, from the broadband network elements 6. For instance, the display device 20 may be utilized to view a “green light” indicator generated by a broadband network element 6 representing confirmation of a loopback test command.

In the remote terminal site 4, the communications adapter 24 connects the telephone 26 to the gateway 12 thus enabling VoIP service for the telephone 26 such that the telephone 26 may make and receive calls over the network 10. In accordance with various embodiments, the communications adapter 24 may comprise a terminal adapter for providing VoIP service over a broadband network. As known to those skilled in the art, a terminal adapter converts standard telephony signals into data signals for communication over a broadband network and vice versa. For broadband network communications, terminal adapters may utilize Session Initiated Protocol (also known as Session Initiation Protocol or “SIP”, which is a signaling protocol for Internet telephony. SIP can establish sessions for IP telephony services and features for deployment over IP networks. In accordance with various embodiments, the telephone 26 may be utilized by a technician located at the remote terminal site 4 for communicating with the central office 2 using VoIP without potentially causing an interruption in customer voice traffic being communicated over narrowband communications lines 23 to the central office 2.

It will be appreciated by those skilled in the art that in accordance with various embodiments, the functionality of the gateway 12 and the communications adapter 24 may be integrated into one device and the functionality of the communications adapter 24 and the telephone 26 may also be integrated into one device. It should further be appreciated that the functionality of the gateway 12, the communications adapter 24, and the telephone 26 may also be integrated into the test/monitoring module 14 and function together as a single remote terminal device, in a manner known to those skilled in the art.

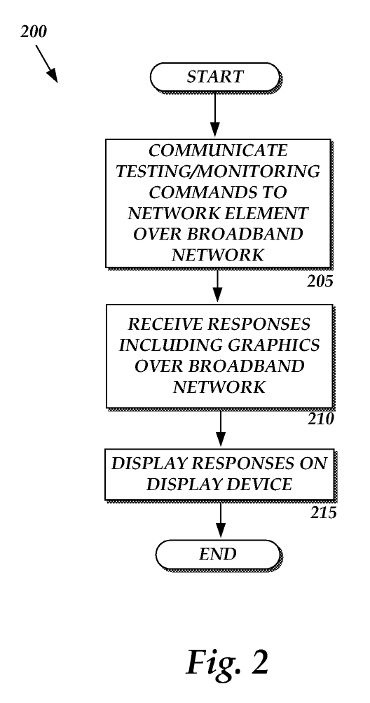

Referring now to FIG. 2, an illustrative routine 200 will be described illustrating a process performed by the application program 32 executing on the test/monitoring module 14 for remotely monitoring and testing network elements in a broadband communications network from the remote terminal site 4, in accordance with various embodiments. When reading the discussion of the routines presented herein, it should be appreciated that the logical operations of various embodiments of the present invention are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated in FIG. 2 and making up the embodiments of the present invention described herein are referred to variously as operations, structural devices, acts or modules. It will be recognized by one skilled in the art that these operations, structural devices, acts and modules may be implemented in software, in firmware, in special purpose digital logic, and any combination thereof without deviating from the spirit and scope of the present invention as recited within the claims set forth herein.

The routine 200 begins at operation 205, where the test/monitoring module 14 communicates testing and monitoring commands to the broadband network elements 6 over the network interface 16. In particular, the application program 32 may instruct the test/monitoring module 14 to send testing and monitoring commands over the network interface 16 to the gateway 12 for communication over the network 10. For instance, the test/monitoring module 14 may send a loopback test command to one of the broadband network elements 6, such as an ATM switch, in the central office 2, a monitoring command for retrieving any alarms generated by one of the broadband network elements 6, or a monitoring command for retrieving a current status of a specified card or a specified shelf in one of the broadband network elements 6. It should be understood that in accordance with other embodiments, the test/monitoring module 14 may be configured to communicate other types of commands to the broadband network elements 6 such as provisioning commands.

From operation 205, the routine 200 continues to operation 210, where the test/monitoring module 14 receives responses, including graphics, from one or more of the broadband network elements 6 over the network interface 16. In particular, the application program 32 may instruct the test/monitoring module 14 to download graphics from one of the broadband network elements 6 which indicate a confirmation that a loopback test command was successfully received and/or executed, currently displayed alarms on one or more cards or a shelf in a broadband network element 6, and/or a current status of a card or shelf in a broadband network element 6.

From operation 210, the routine 200 continues to operation 215, where the test/monitoring module 14 displays the received responses, including graphics, received from the broadband network elements 6 on the display device 20. In particular, the application program 32 may instruct the test/monitoring module 14 to display the graphics. The graphics displayed by the test/monitoring module 14 may comprise a visual representation of a card or shelf on a broadband network element 6 including an indication of a current status such as showing an LED being lit indicating that the card or shelf is in an alarm state or that a loopback command was successively received and/or executed. The routine 200 then ends.

Based on the foregoing, it should be appreciated that various embodiments of the present invention, among others, are directed to providing a system for remotely monitoring testing network elements using a broadband communications network. It will be apparent by those skilled in the art that various modifications or variations may be made in the present invention without departing from the scope or spirit of the invention. Other embodiments of the present invention will be apparent to those skilled in the art from consideration of the specification and practice of the invention disclosed herein.

I claim:

1. An apparatus for remotely monitoring and testing network elements in a broadband communications network, comprising:
a remote terminal device having a network interface for communicating with at least one network element over the broadband communications network, the remote terminal device configured for communicating commands for monitoring and testing the at least one network element and retrieving graphics comprising responses to the monitoring and testing commands for display on the remote terminal device over the network interface; and
a communications adapter for enabling voice communications with at least one network element site comprising the at least one network element over the broadband communications network.

2. The apparatus of claim 1 further comprising a network gateway in communication with the broadband communications network for communicating the commands from the remote terminal device to the at least one network element over the broadband communications network;

3. The apparatus of claim 1, wherein the remote terminal device is further configured for communicating commands for provisioning the at least one network element.

4. The apparatus of claim 1, wherein the commands for testing the at least one network element comprises a loopback test command.

5. The apparatus of claim 1, wherein the commands for monitoring the at least one network element comprises a command for retrieving alarms generated by the at least one network element.

6. The apparatus of claim 1, wherein the graphics comprising responses to the monitoring and testing commands comprise a current status of the at least one network element.

7. The apparatus of claim 6, wherein the current status of the at least one network element comprises at least one of a network element card status and a network element shelf status.

8. The apparatus of claim 1, wherein the graphics comprising responses to the testing commands comprise a visual confirmation of a testing command executed in the at least one network element.

9. The apparatus of claim 1, wherein the communications network is a digital subscriber line communications network.

10. The apparatus of claim 1, wherein the at least one network element is a central office switch.

11. The apparatus of claim 1, wherein the network interface comprises an Ethernet network interface.

12. The apparatus of claim 1, wherein the communications adapter enables voice communications with at least one network element site using Voice over Internet Protocol.

13. A method for remotely monitoring and testing network elements in a digital subscriber line communications network, comprising:
communicating a command for at least one of monitoring and testing at least one network element over the digital subscriber line communications network;
receiving a plurality of graphics in response to the command for at least one of monitoring and testing from the at least one network element over the digital subscriber line network; and
displaying the plurality of graphics on a display device.

14. The method of claim 13, wherein communicating a command for at least one of monitoring and testing to at least one network element over the digital subscriber line communications network comprises communicating at least one of a loopback test command and a command for retrieving alarms generated by the at least one network element.

15. The method of claim 13, wherein displaying the plurality of graphics comprises displaying a current status of the at least one network element and a visual confirmation of the command for at least one of monitoring and testing executed in the at least one network element, wherein the current status of the at least one network element comprises a network element card alarm status.

16. A computer-readable medium comprising computer executable instructions which, when executed on a computer, will cause the computer to perform a method for remotely monitoring and testing network elements in a digital subscriber line communications network, the method comprising:
initiating commands for monitoring and testing at least one network element over the digital subscriber line communications network;
receiving graphics comprising responses to the monitoring and testing commands from the at least one network element over the digital subscriber line network; and
displaying the received graphics.

17. The computer-readable medium of claim 16, wherein the commands for testing the at least one network element comprises a loopback test command.

18. The computer-readable medium of claim 16, wherein the commands for monitoring the at least one network element comprises a command for retrieving alarms generated by the at least one network element.

19. The computer-readable medium of claim 16, wherein the graphics comprising responses to the monitoring and testing commands comprise a current status of the at least one network element.

20. The computer-readable medium of claim 16, wherein the graphics comprising responses to the testing commands comprise a visual confirmation of a testing command executed in the at least one network element.
